(19) United States
(12) Patent Application Publication
(10) Pub. No.: US 2017/0124688 A1
(43) Pub. Date: May 4, 2017

(54) IMAGE PROCESSOR, IMAGE PROCESSING METHOD, AND MEASURING APPARATUS

(71) Applicant: CANON KABUSHIKI KAISHA, Tokyo (JP)

(72) Inventor: Takanori Uemura, Saitama-shi (JP)

(21) Appl. No.: 15/332,174

(22) Filed: Oct. 24, 2016

(30) Foreign Application Priority Data
Nov. 2, 2015 (JP) 2015-215408

(51) Int. Cl. G06T 5/00; G06T 7/60; G06T 7/00

(52) U.S. Cl. CPC G06T 5/006; G06T 7/0081; G06T 7/0085; G06T 7/602; G06T 2207/10152; G06T 2207/20024; G06T 2207/20192

(57) ABSTRACT

An image processor that processes an image of an object obtained by a predetermined field of view 150 comprising: a storage unit that stores a correction table 152 that holds a correction value determined based on distortion of the image in each of a plurality of regions 153 obtained by dividing the field of view 150; and a calculation unit that calculates an edge position 154 of the object based on the image, and corrects the edge position 154 that has been calculated by using the correction table 152, wherein the calculation unit reads out the correction value held in the region including the edge position 154 that has been calculated from the correction table 152 stored in the storage unit, and corrects the edge position 154 that has been calculated by the correction value.

### BACKGROUND OF THE INVENTION

Field of the Invention

The present invention relates to an image processor, an image processing method, and a measuring.

Description of the Related Art

An apparatus exists that determines the shape of an object by obtaining an image of the object and calculating a distance between edges of the object based on the image. If the obtained image is distorted, calculating a distance between edges with high accuracy is difficult. Distortion of the image can occur due to, for example, a manufacturing error or an assembly error (for example, eccentricity) of an optical component provided in the apparatus (for example, a lens). As an apparatus that determines an amount of the distortion of a part of the image beforehand, calculates the amount of the distortion of the entire image based on the amount of the distortion, and corrects the distortion, an apparatus exists that uses a polynomial (Japanese Patent Application Laid-Open Publication No. 2010-32260) and an apparatus exists that uses an interpolation method (Japanese Patent No. 4445717).

However, if locally large distortion occurs, it is difficult for the apparatus in Japanese Patent Application Laid-Open Publication No. 2010-32260 to calculate the amount of the distortion correctly. In contrast, although the apparatus in Japanese Patent No. 4445717 can respond to such a distortion, the calculation load increases due to the interpolation method, and a large amount of time for calculating the amount of the distortion is required.

### SUMMARY OF THE INVENTION

The object of the present invention is to provide, for example, an image processor that is advantageous in correcting an amount of distortion of an image.

In order to solve the above problems, the present invention is an image processor that processes an image of an object obtained by a predetermined field of view comprising: a storage unit that stores a correction table that holds a correction value determined based on distortion of the image in each of a plurality of regions obtained by dividing the field of view, and a calculation unit that calculates an edge position of the object based on the image, and corrects the edge position that has been calculated by using the correction table, wherein the calculation unit reads out the correction value held in the region including the edge position that has been calculated, from the correction table stored in the storage unit, and corrects the edge position that has been calculated by the correction value.

Further features of the present invention will become apparent from the following description of exemplary embodiments with reference to the attached drawings.

### BRIEF DESCRIPTION OF THE DRAWINGS

FIG. 1 is a schematic diagram that illustrates a configuration of a measuring apparatus applied with an image processor according to a first embodiment.

FIG. 2 is a flow chart that corrects distortion of an image.

FIG. 3A illustrates an image of an object.

FIG. 3B illustrates a correction table.

FIG. 3C illustrates the detected edge.

FIG. 3D illustrates edge coordinates.

FIG. 4 illustrates a graph of an amount of distortion with respect to the X-direction in the image.

FIG. 5 illustrates a correction table that is read by an image processor according to a second embodiment.

### DESCRIPTION OF THE EMBODIMENTS

Hereinafter, a detailed description will be given of embodiments of the present invention with reference to the accompanying drawings and the like.

### First Embodiment

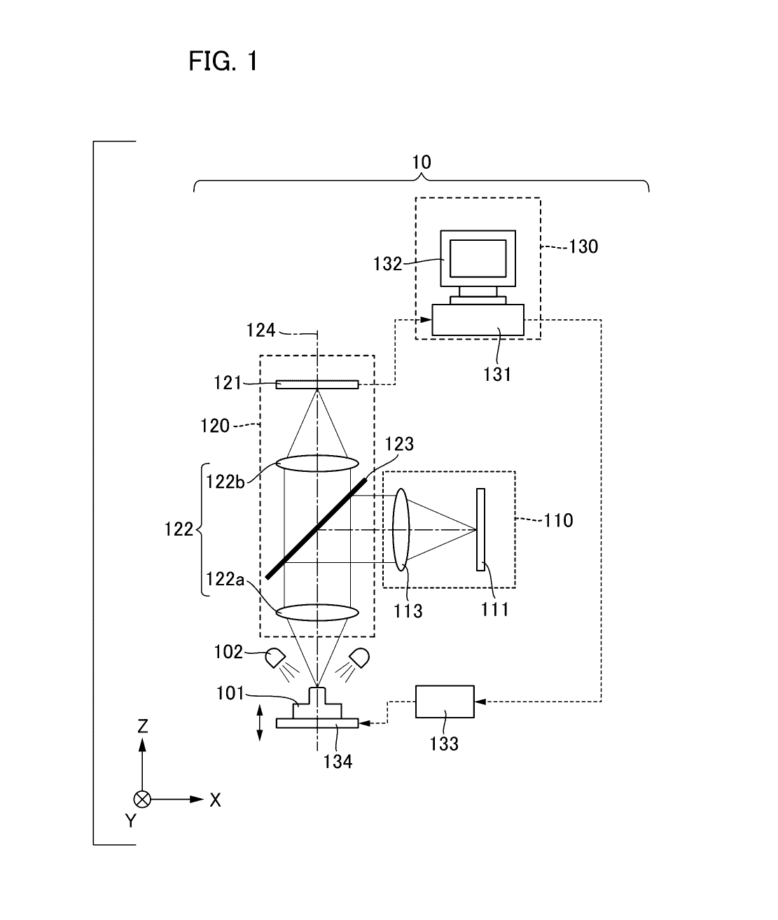

FIG. 1 is a schematic diagram that illustrates a configuration of a measuring apparatus to which an image processor according to a first embodiment of the present invention is applied. A measuring apparatus 10 includes a first illumination device 102, a second illumination device 110, an image obtaining unit 120, and an image processor 130. In the drawing, the Z-axis is taken in the perpendicular direction (vertical direction), and the X-axis and the Y-axis that are orthogonal to each other are taken in a plane perpendicular to the Z-axis. An object 101 is placed on a stage 134. The stage 134 can be driven by an actuator 133. The first illumination device 102 is a ring illumination apparatus configured by a plurality of light sources arranged in a ring, and illuminates the object 101 from oblique directions. The second illumination device 110 is a coaxial illumination device and illuminates the object 101 from the vertical direction. The second illumination device 110 includes a light source 111 and a lens 113. For example, an LED, a lamp, or a fluorescent lamp can be used to serve as the light source 111. The lens 113 collimates a light emitted from the light source 111, and guides it to the image obtaining unit 120. The measuring apparatus 10 may include any illumination devices such as a transmission illumination device, a dome illumination device, and the like.

The image obtaining unit 120 has a photodetector 121, an objective lens 122, and a half mirror 123. On the photodetector 121, an image from the object 101 (a reflected light or a scattered light) is formed (is received). For example, a CCD or a CMOS are used to serve as the photodetector 121. The objective lens 122 includes a first lens group 122a and a second lens group 122b, and forms an image of the object 101 on the photodetector 121. With respect to the first lens group 122a and the second lens group 122b, optical elements may partially or entirely be configured by a mirror. The half mirror 123 is placed between the first lens group 122a and the second lens group 122b.

A process in which an image of the object 101 is formed on the photodetector 121 is as follows. The first illumination device 102 controls each light source separately and illuminates the object 101 from an oblique direction of any orientation. The light introduced from the second illumination device 110 is partially reflected by the half mirror 123, is collected by the first lens group 122a, and is illuminated to the object 101 in the perpendicular direction. The stage 134 can be driven in a direction parallel to the optical axis 124 of the objective lens 122 by the actuator 133, and the focusing can be performed on the surface of the object 101. In order to measure an object larger than the field of view of the objective lens 122, the stage 134 may be enabled to be driven not only in a direction parallel to the optical axis 124, but also in the perpendicular direction (XY direction).

The light reflected or scattered by the object 101 is again taken into the objective lens 122, transmitted through the half mirror 123, and the image of the object 101 is formed on the photodetector 121 through the first lens group 122a. The image of the object 101 that is formed on the photodetector 121 is transferred to the image processor 130.

The image processor 130 is, for example, a personal computer or a work station, and includes a display means 132 such as a liquid crystal monitor and CRT, a storage unit 131 such as a hard disk and a SSD, and a calculating unit (not illustrated). The display means 132 displays a calculation result for the shape information of the object 101. The storage unit 131 stores and reads out various programs and data. The various programs include a calculation program for calculating the shape of the object 101. The image processor 130 (calculating unit) reads the calculation program and executes it. When the calculation program is executed, the image processor 130 detects an edge from the image of the object 101, and further provides a function that corrects the edge. A correction method will be described in detail below.

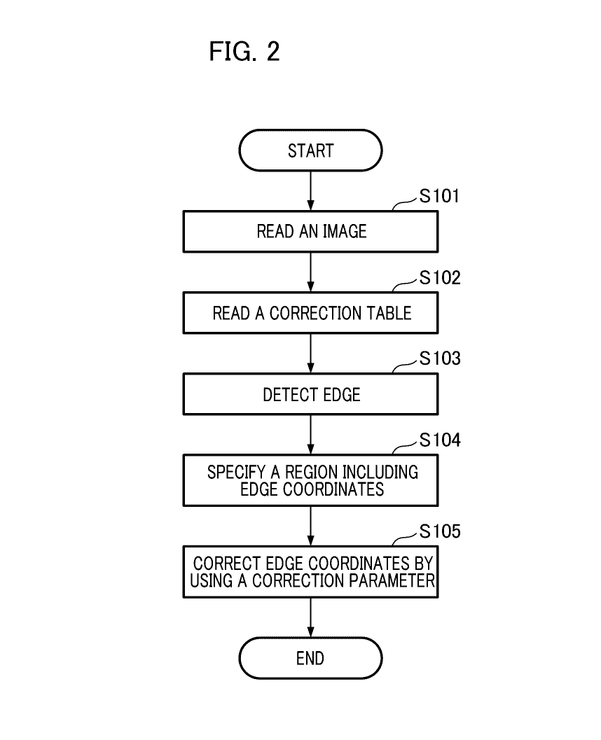

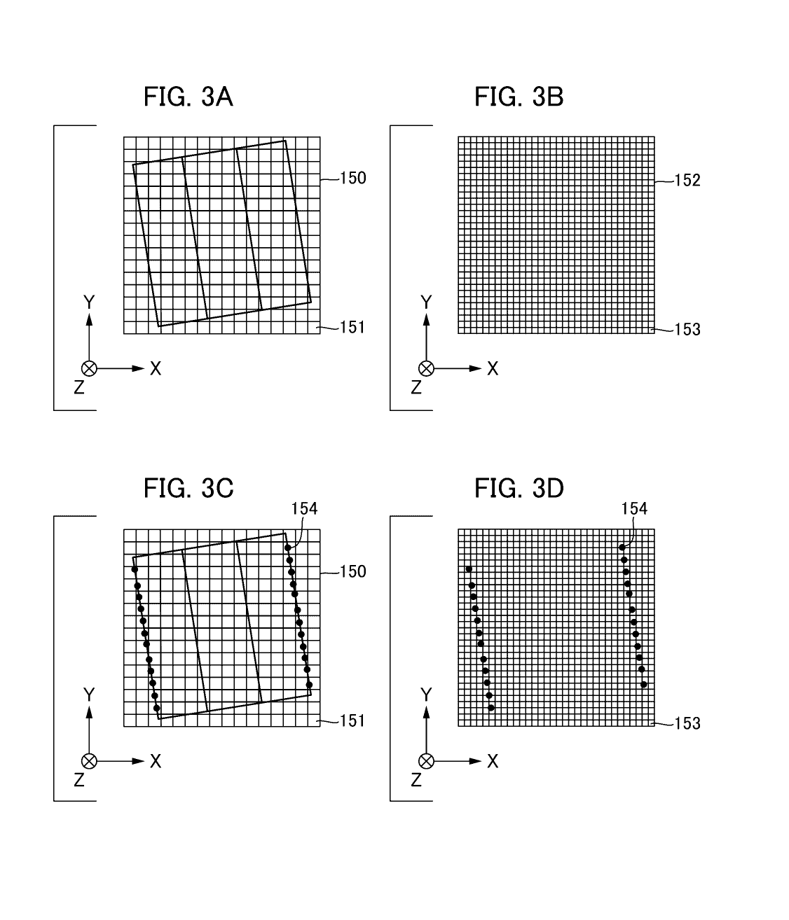

FIG. 2 is a flow chart that corrects distortion of the image executed by the image processor 130. FIGS. 3A to 3D illustrate an image of the object 101, a correction table, a detected edge, and edge coordinates. A description will be given of a method of correcting a distortion in an image by using these diagrams. When the calculation program is executed, the image processor 130 reads the image of the object 101 that was obtained by the photodetector 121 (S101). FIG. 3A illustrates the image formed on a predetermined field of view 150 of the photodetector 121. The field of view 150 is configured by a plurality of pixels 151, and the object 101 is a shaded part in the field of view 150. The pixel 151 holds the information about an amount of light that has been received by the photodetector 121. Subsequently, the image processor 130 reads out a correction table 152 shown in FIG. 3B from the storage unit 131 (S102). The correction table 152 is configured by a plurality of divided regions 153, each of which holds a distortion correction parameter (correction value) in that region. In the present embodiment, the size of the region 153 is smaller than the pixel 151, which is a half size of the pixel 151. Additionally, although the region 153 is shown by a square, it may have other polygons, for example, a triangle, a rectangle, and the like.

In S103, the image processor 130 executes image processing, and detects an edge position from the image of the object 101 shown by shading with sub-pixel accuracy. FIG. 3C illustrates an example in which the edge detection is executed in the two sides of the object 101. As shown in FIG. 3C, the edge coordinates 154 are calculated for each of the pixels 151 by using edge detection. Any algorithm including the Canny method, the Sobel filter, and the like can be used for the edge detection.

In S104, the image processor 130 specifies where the edge coordinates (edge position) 154 should be included in the region 153 in the correction table 152. As shown in FIG. 3D, each of the edge coordinates 154 is included in any of the regions 153. In S105, the image processor 130 corrects each of the edge coordinates 154 by using the correction parameters held in each of the regions 153. Specifically, the edge coordinates are corrected by adding or subtracting the correction parameters from the coordinate values. It is possible to correct the distortion in a short time because a large load calculation is not used, as in interpolation.

Note that the correction table 152 is produced by measuring an amount of the distortion in advance. For example, the amount can be measured by obtaining a grid or dot test target image having a known pattern.

In order to measure the shape of the object with high accuracy, determination of the edge coordinates with high accuracy is required. The general algorithm accuracy that detects an edge with sub-pixel accuracy using the Canny method is ⅕ or less and 1/100 or more of the pixel. If the error of the distortion correction is much larger than the accuracy of the edge detection, the measurement accuracy is dominated by the error of the distortion correction, and accordingly, the distortion should be corrected with higher accuracy. In contrast, if the error of the distortion correction is much smaller than the accuracy of the edge detection, the measurement accuracy is determined by the accuracy of the edge detection, and further correction of the distortion is thereby meaningless.

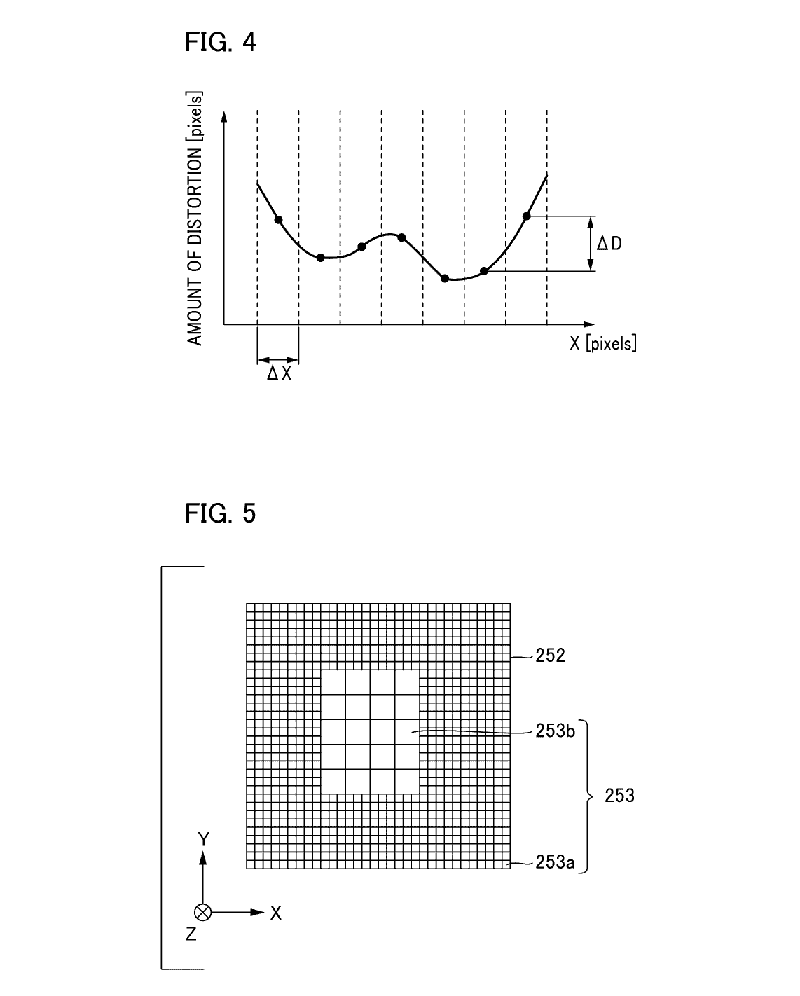

FIG. 4 is a graph showing an amount of distortion with respect to the X-direction in the image. Δx represents a size of the region 153 in the x-direction. Each region 153 holds the amount of the distortion shown by black dots on the curve of the graph as correction parameters. The correction accuracy is determined by the difference ΔD of each of the amounts of the distortion corresponding to the adjacent regions 153, and the smaller ΔD is, the better the accuracy is. There is a case in which the size Δx of the region 153 increases in response to the increase of ΔD, and ΔD decreases in response to the decrease of Δx. However, if Δx decreases, the number of the regions 153 that configures the correction table increases, and the data amount of the correction table increases. If Δx decreases unnecessarily, the data amount increases and the storage unit 131 is compressed, and consequently, the calculation time may increase. In order to achieve both of two requirements of the correction accuracy and the calculation, the correction table is desirably produced by determining Δx such that the maximum value of ΔD in the correction table has a level that is the same as the edge detection accuracy, that is, 1/100 or more and ⅕ or less of the pixel. Additionally, although the amount of the distortion with respect to the X-direction in the image was described, the amount of the distortion with respect to the Y-direction in the image is the same as well.

Note that the present invention may be combined with a known distortion amount correction technique, for example, polynomial fitting. An asymmetric component of the distortion caused by barrel or pincushion distortion and by the eccentricity of the lens and the like is expressed with high accuracy by fitting using a polynomial of low-order (for example, 1st to 5th order). The correction amount is calculated by substituting the edge coordinates in this polynomial. An amount of distortion that changes locally due to the manufacturing error of the lens, for example, ripple, which also remains after the correction by polynomial fitting, is corrected using the correction table as described above. Because global distortion is corrected by polynomial fitting, ΔD decreases by that amount, and the correction accuracy improves. Thus, the image processor of the present embodiment can correct the amount of the locally large distortion in a short time with high accuracy.

As described above, according to the present embodiment, it is possible to provide an image processor that is advantageous in correcting the amount of the distortion of the image.

### Second Embodiment

Next, a description will be given of an image processor according to a second embodiment of the present invention. The image processor according to the present embodiment differs from the first embodiment in the correction table to be read out. FIG. 5 illustrates a correction table 252 read out by the image processor according to the present embodiment. The region 253 included in the correction table 252 is different from the region 153 included in the correction table of the first embodiment, and has a region 253a and a region 253b that are different in size. The region 253a is ½ of the pixel size, and region 253b is 3/2 of the pixel size.

At a position having a small amount of change of the distortion, even if the size Δx of the region 253 is increased, ΔD does not exceed an acceptable value for the correction. In contrast, at a position having a large amount of change of the distortion, ΔD that is necessary for correction cannot be obtained unless the size Δx of the region 253 is decreased. In many cases, the amount of change of the distortion is not uniform in the image. Accordingly, preferred Δx differs depending on the positions in the image. FIG. 5 shows a case in which, in the central portion, the amount of change of the distortion is smaller than its surroundings. In this case, increasing the size of the region 253b as described above does not significantly affect the measurement accuracy. Additionally, the amount of data of the correction table can be reduced by increasing the size of a part of the region, and high speed correction can thereby be performed without compressing the storage unit 131. Note that, in the present embodiment, two types of the region size are used, but three or more types of the region size may be used. Thus, it is possible to provide an image processor that is advantageous in correcting the amount of the distortion of the image by the present embodiment as well.

Note that although the amount of the distortion in the above embodiment is presumed to occur due to the distortion of the objective lens 122, the present embodiment can also be corresponded to the amount of the distortion that occurs due to other factors.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-215408 filed on Nov. 2, 2015, which are hereby incorporated by reference herein in its entirety.

1. An image processor that processes an image of an object obtained by a predetermined field of view comprising:
a storage unit that stores a correction table that holds a correction value determined based on distortion of the image in each of a plurality of regions obtained by dividing the field of view; and
a calculation unit that calculates an edge position of the object based on the image, and corrects the edge position that has been calculated by using the correction table,
wherein the calculation unit reads out the correction value held in the region including the edge position that has been calculated, from the correction table stored in the storage unit, and corrects the edge position that has been calculated by the correction value.

2. The image processor according to claim 1,
wherein the size of the plurality of regions is determined such that the maximum value of the difference of the correction values held in the regions adjacent to each other is 1/100 or more and ⅕ or less of the pixel.

3. The image processor according to claim 1,
wherein each of the plurality of regions is different in size.

4. The image processor according to claim 1,
wherein the calculation unit corrects the edge position that has been calculated by using a polynomial that determines a correction value of the image, based on the edge position that has been calculated, in addition to the correction table.

5. An image processing method that processes an image of an object obtained by a predetermined field of view comprising steps of:
reading-out the image and a correction table that holds a correction value determined based on distortion of the image in each of a plurality of regions obtained by dividing the field of view;
calculating an edge position of the object based on the image; and
reading out the correction value held in the region including the edge position that has been calculated from the correction table that has been read out, and correcting the edge position that has been calculated by the correction value.

6. A measuring apparatus that measures the shape of an object by calculating an edge position of the object based on an image of the object and determining a distance between edges of the object based on the edge position that has been calculated,
wherein the edge position that has been calculated is corrected by using an image processor that processes the image of the object obtained by a predetermined field of view comprising:
a storage unit that stores a correction table that holds a correction value determined based on distortion of the image in each of a plurality of regions obtained by dividing the field of view; and
a calculation unit that calculates an edge position of the object based on the image, and corrects the edge position that has been calculated by using the correction table,
wherein the calculation unit reads out the correction value held in the region including the edge position that has been calculated, from the correction table stored in the storage unit, and corrects the edge position that has been calculated by the correction value.

7. A measuring apparatus that measures a shape of an object by calculating an edge position of the object based on an image of the object and determining a distance between edges of the object based on the edge position that has been calculated,
wherein the edge position that has been calculated is corrected by using an image processing method that processes the image of the object obtained by a predetermined field of view comprising steps of:
reading-out the image and a correction table that holds a correction value determined based on distortion of the image in each of a plurality of regions obtained by dividing the field of view:
calculating an edge position of the object based on the image; and
reading out the correction value held in the region including the edge position that has been calculated from the correction table that has been read out, and correcting the edge position that has been calculated by the correction value.
